(19) United States
(12) Patent Application Publication
(10) Pub. No.: US 2015/0231997 A1
(43) Pub. Date: Aug. 20, 2015

(54) VEHICLE SEAT, AND SEAT FRAME FOR VEHICLE SEAT

(71) Applicants: Hiroyuki Itoi, Tochigi (JP); Takahiro Niimura, Tochigi (JP)

(72) Inventors: Hiroyuki Itoi, Tochigi (JP); Takahiro Niimura, Tochigi (JP)

(73) Assignee: TS TECH CO., LTD., Asaka-shi (JP)

(21) Appl. No.: 14/425,350

(22) PCT Filed: Sep. 3, 2012
(86) PCT No.: PCT/JP2012/072390

§ 371 Date: Mar. 3, 2015

(51) Int. Cl. B60N 2/44; B60N 2/68; B23K 26/20; B60N 2/48

(52) U.S. Cl. CPC B60N 2/44; B60N 2/48; B60N 2/682; B23K 26/20; B60N 2002/4888

(57) ABSTRACT

Provided are a vehicle seat and a seat frame for the vehicle seat being configured in such a manner that a headrest bracket is welded and fixed to an upper frame, in which the thermal strain of the welded portion is small and the manufacturing time thereof is shortened by high-speed welding. A seat frame for a vehicle seat has a seat back frame with an upper frame and a bracket joined to the upper frame and holding a pillar of a headrest, and the bracket is fixed to the upper frame by laser-welding. The bracket supports the pillar of the headrest via a support guide, and in at least a portion of the range in the up and down direction where the support guide is provided, the bracket is laser-welded to the upper frame in the up and down direction.

### CROSS REFERENCE TO RELATED APPLICATIONS

This application is a National Stage Entry application of PCT Application No. PCT/JP2012/072390, filed Sep. 3, 2012.

### BACKGROUND

Disclosed herein is a vehicle seat and a seat frame for a vehicle seat provided with a support structure supporting a head rest on a backrest.

Conventionally, a head rest support structure for supporting a pair of rod-shaped head rest pillars extended from the lower end of a head rest by means of a pair of cylindrical head rest brackets welded and fixed to two flat surfaces which are formed by crushing on an upper frame of a seat back frame of a vehicle seat is known (for example, Japanese Patent Document No 2012-46158 A (“the '158 Document”), see, e.g., ¶0065, FIG. 5-1, etc.).

In the '158 Document, a pair of wall portions arranged in a standing condition toward the front of the seat from the flat surface are formed by crushing on both sides of the flat surface, a rear surface of the head rest bracket is welded to the flat surface, and a pair of side surfaces of the head rest bracket are welded to the pair of wall portions. Thereby, the connectivity of the upper frame and the head rest brackets is improved.

However, in the conventional art such as the '158 Document, the joining of the head rest brackets to the upper frame is performed by arc welding such as TIG welding or MIG welding with the use of a filler metal so that influences such as deformation due to welding heat are prone to occur and also the welding speed is slow.

### SUMMARY

Various embodiment described below consider the above problems, and an object thereof is to provide a vehicle seat and a seat frame for the vehicle seat being configured in such a manner that a headrest bracket is welded and fixed to an upper frame, in which the thermal strain of the welded portion is small and the manufacturing time thereof is shortened by high-speed welding.

According to a seat frame for a vehicle seat of an embodiment, the above problem is solved by the seat frame having a seat back frame with an upper frame and a bracket joined to the upper frame and holding a pillar of a headrest, in which the bracket is fixed to the upper frame by laser-welding.

In this way, since the upper frame and the bracket are connected by laser-welding with the use of a heat source of high energy density, high-speed welding is possible and the welding process of the bracket to the upper frame can be completed in a short time. Moreover, welding heat influence is significantly reduced and thermal strain due to welding is minimized so that the yield of the product after welding can be improved.

In an embodiment, it is preferable that the bracket supports the pillar of the headrest via a support guide, and in at least a portion in the up and down direction of the range where the support guide is provided, the bracket is laser-welded to the upper frame in the up and down direction.

In this way, in at least a portion in the up and down direction of the range where the support guide is provided, the bracket is laser-welded to the upper frame in the up and down direction so that the portion supporting the support guide of a wall surface of the bracket can be suppressed from being opened to bulge outwardly due to the thermal strain. The space between the support guide and the bracket due to opening of the wall surface of the bracket is not generated, thereby suppressing shaking of the support guide in the bracket.

In an embodiment, it is preferable that the bracket includes a rear surface on the rear of the seat, a pair of side surfaces provided on side portions of the seat width direction, and corners between the side surfaces and the rear surface, that on the corners, R-shaped portions connecting the rear surface and the side surfaces by a curve surface are provided, that the upper frame includes a flat surface portion in which the front surface side of the seat is formed into a flat surface, that a welding mark of laser-welding extending in the up and down direction straddles between the flat surface portion and the R-shaped portion, and that the welding mark includes a plurality of first welding mark pieces and second welding mark pieces formed along the different directions from each other and are continuously aligned up and down alternately.

In this way, the welding mark includes the plurality of first welding mark pieces and second welding mark pieces formed along the different directions from each other and are continuously aligned up and down alternately so that the welding mark forms as a whole a zigzag-shape or the like. Even in a case where there exists a gap between the bracket and the abutting surface of the upper frame, stable fixation is possible and an amount of the welded portion to protrude outwardly in the seat width direction from the R-shaped portion and the side surfaces of the bracket can be reduced.

In an embodiment, it is preferable that the welding mark includes a connection portion connecting the R-shaped portion to the flat surface portion to bridge them, and that the connection portion is arranged in a region surrounded by an extension surface of the side surface and the R-shaped portion and the flat surface portion.

As thus configured, even in a case where there exists a gap between the bracket and the flat surface portion of the upper frame, stable fixation is possible and an amount of the welded portion to protrude outwardly in the seat width direction from the R-shaped portion and the side surfaces of the bracket can be reduced.

In an embodiment, it is preferable that a folded portion in which the side surface protrudes outwardly in the width direction is provided on the corner, and that the folded portion and the flat surface are laser-welded.

In this way, the folded portion is provided, and the folded portion and the flat surface portion are laser-welded so that the gap between the bracket and the flat surface portion of the upper frame can be reduced, and stable fixation is possible.

In an embodiment, it is preferable that the upper frame is formed of a pipe-shaped body, that the flat surface portion in which the front surface side of the upper frame is recessed, and a pair of recess side surfaces provided on both sides of the seat width direction of the flat surface portion and inclined to connect the flat surface portion and the front surface of the pipe-shaped portion of the upper frame are provided in the central portion of the seat width direction of the upper frame, and that the corner and the flat surface portion are laser-welded at a position facing the recess side surface.

By laser-welding, the welding mark is kept within a narrow area, and protrusion of the laser-welded portion laterally of the seat can be reduced. Therefore, by laser-welding the corner and the flat surface portion at the position facing the recess side surface in this way, the recess side surface can be brought close to the laser-welded portion side, and the rigidity of the upper frame is easy to be secured.

In an embodiment, it is preferable that a bead center of the welding mark is located between an outer end portion of the seat width direction of the folded portion and an outer end portion of the seat width direction of a surface contacted by the flat surface portion and the rear surface.

As thus configured, in a case where the bracket is configured in such a manner that the folded portion is provided on the corner of the rear surface and the side surface, further stable fixation is possible.

In an embodiment, it is preferable that the welding mark reaches the outer end portion of the seat width direction of the folded portion.

As thus configured, more stable fixation is possible.

In an embodiment, it is preferable that the welding mark does not reach a surface on the rear of the upper frame.

As thus configured, the rigidity of the upper frame can be suppressed from being excessively lowered in portion due to welding, in the installation portion of the bracket in the seat width direction.

In an embodiment, it is preferable that the bracket and the upper frame have molten pool traces formed by laser-welding, and the molten pool traces have a depth of 5-20% of the thickness of the bracket and the upper frame respectively.

As thus configured, unlike in the case of keyhole welding by which a deep fused portion bead remains, the strength of the welded portion can be suppressed from decreasing, and the fixed strength and the rigidity of the bracket and the upper frame can be secured.

In an embodiment, it is preferable that the first welding mark pieces and the second welding mark pieces are inclined with respect to the insertion direction of the pillar of the head rest into the bracket, and that a distance A of the first welding mark piece and the second welding mark piece in a direction perpendicular to the insertion direction and a sum B of the lengths of the insertion direction of the adjacent pair of the first welding mark piece and the second welding mark piece are smaller than a curvature radius R of the R-shaped portion.

As thus configured, stable fixation is possible while suppressing the protrusion amount of the welded portion to the seat horizontal direction.

According to a vehicle seat of an embodiment, the above problem is solved by the vehicle seat having a seat back frame with an upper frame and a bracket joined to the upper frame and holding a pillar of a headrest in which the bracket is fixed to the upper frame by laser-welding.

According to an embodiment, since the upper frame and the bracket are connected by laser-welding with the use of a heat source of high energy density, high-speed welding is possible and the welding process of the bracket to the upper frame can be completed in a short time. Moreover, welding heat influence is significantly reduced and thermal strain due to welding is minimized so that the yield of the product after welding can be improved.

According to an embodiment, in at least a portion in the up and down direction of the range where the support guide is provided, the bracket is laser-welded to the upper frame in the up and down direction so that the portion supporting the support guide of a wall surface of the bracket can be suppressed from being opened to bulge outwardly due to the thermal strain. The space between the support guide and the bracket due to opening of the wall surface of the bracket is not generated, thereby suppressing shaking of the support guide in the bracket.

According to an embodiment, the welding mark includes the plurality of first welding mark pieces and second welding mark pieces formed along the different directions from each other and continuously aligned up and down alternately so that the welding mark forms as a whole a zigzag-shape or the like. Even in a case where there exists a gap between the bracket and the abutting surface of the upper frame, stable fixation is possible and an amount of the welded portion to protrude outwardly in the seat width direction from the R-shaped portion and the side surfaces of the bracket can be reduced.

According to an embodiment, even in a case where there exists a gap between the bracket and the flat surface portion of the upper frame, stable fixation is possible and an amount of the welded portion to protrude outwardly in the seat width direction from the R-shaped portion and the side surfaces of the bracket can be reduced.

According to an embodiment, the folded portion is provided, and the folded portion and the flat surface portion are laser-welded so that the gap between the bracket and the flat surface portion of the upper frame can be reduced, and stable fixation is possible.

According to an embodiment, by laser-welding, the welding mark is kept within a narrow area, and protrusion of the laser-welded portion laterally of the seat can be reduced. Therefore, by laser-welding the corner and the flat surface portion at the position facing the recess side surface in this way, the recess side surface can be brought close to the laser-welded portion side, and the rigidity of the upper frame is easy to be secured.

According to an embodiment, in a case where the bracket is configured in such a manner that the folded portion is provided on the corner of the rear surface and the side surface, further stable fixation is possible.

According to an embodiment, more stable fixation is possible.

According to an embodiment, the rigidity of the upper frame can be suppressed from being excessively lowered in portion due to welding, in the installation portion of the bracket in the seat width direction.

According to an embodiment, unlike in the case of keyhole welding by which a deep fused portion bead remains, the strength of the welded portion can be suppressed from decreasing, and the fixed strength and the rigidity of the bracket and the upper frame can be secured.

According to an embodiment, stable fixation is possible while suppressing the protrusion amount of the welded portion to the seat horizontal direction.

According to an embodiment, since the upper frame and the bracket are connected by laser-welding with the use of a heat source of high energy density, high-speed welding is possible and the welding process of the bracket to the upper frame can be completed in a short time. Moreover, welding heat influence is significantly reduced and thermal strain due to welding is minimized so that the yield of the product after welding can be improved.

### BRIEF DESCRIPTION OF THE DRAWINGS

FIG. 1 is an external perspective view of a vehicle seat according to one embodiment of the present invention.

FIG. 2 is an external exploded perspective view of a seat frame of the vehicle seat according to one embodiment of the present invention.

FIG. 3 is an external perspective view showing a mounting portion of a bracket to an upper frame according to one embodiment of the present invention.

FIG. 4 is a cross-sectional side view showing a supported state of a head rest pillar by the bracket according to one embodiment of the present invention.

FIG. 5 is an enlarged perspective view showing the mounting portion of the bracket to the upper frame according to one embodiment of the present invention.

FIG. 6 is an enlarged plan view showing a welded portion of the bracket to the upper frame according to one embodiment of the present invention.

FIG. 7 is an enlarged cross-sectional plan view showing the welded portion of the bracket to the upper frame according to one embodiment of the present invention.

FIG. 8 is an enlarged plan view showing a welded portion of a bracket to an upper frame according to a modified embodiment of the present invention.

### DETAILED DESCRIPTION

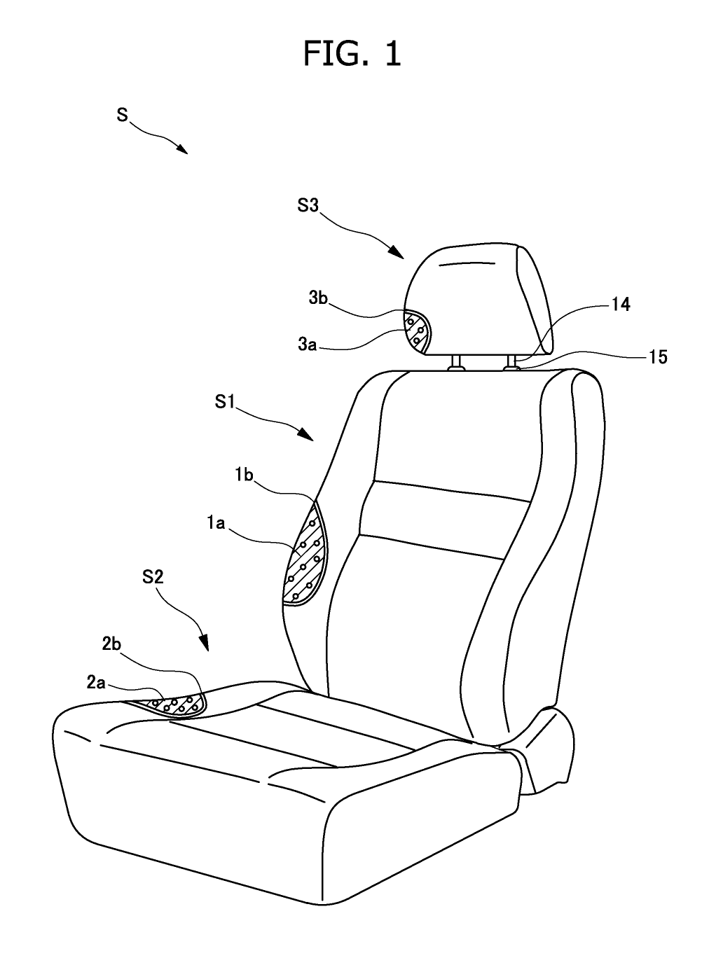

Hereinafter, a vehicle seat and a seat frame for a vehicle seat according to one embodiment of the present invention will be described with reference to FIG. 1 to FIG. 8.

### Vehicle Seat and Seat Frame

As shown in FIG. 1, a vehicle seat S according to the present embodiment is composed of a seat back S1, a seating portion S2, and a head rest S3, and the seat back S1 and the seating portion S2 are formed by placing cushion pads 1a, 2a on a seat frame (not shown) and covering them with skin materials 1b, 2b. Moreover, the head rest S3 is formed by arranging a pad material 3a on a core material (not shown) and covering them with a skin material 3b and is supported by a head rest pillar 14.

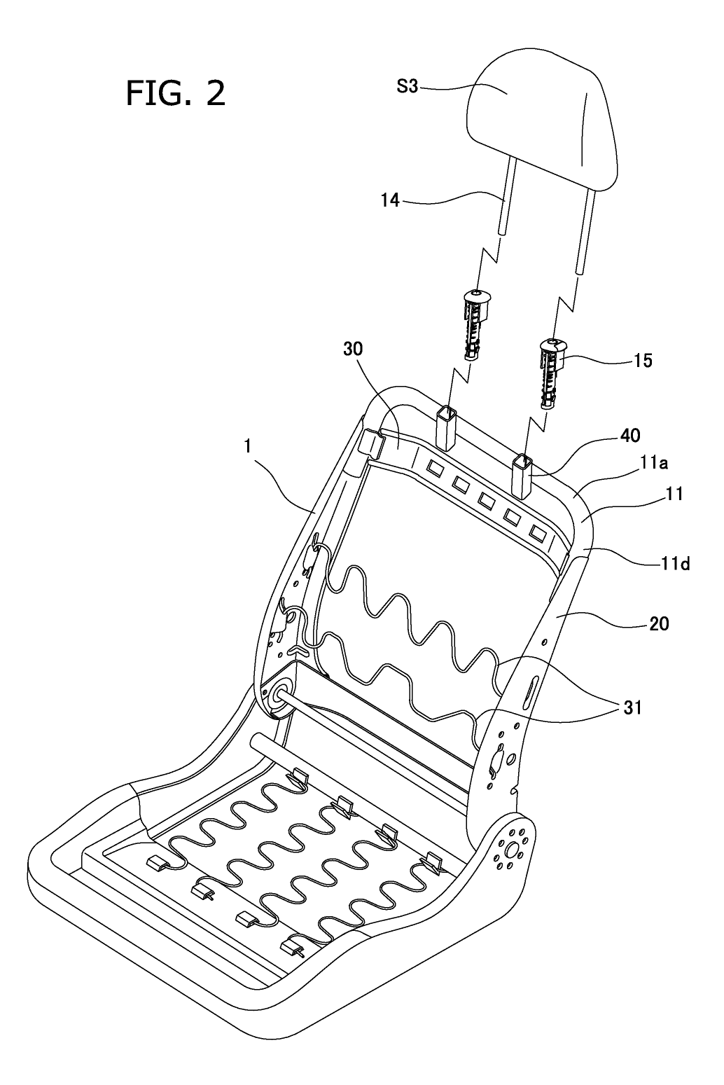

The seat back S1 is formed by placing the cushion pad 1a on a seat back frame 1 and covering them with the skin material 1b from above the cushion pad 1a, and supports the back of an occupant from behind. As shown in FIG. 2, the seat back frame 1 is configured in a frame shape by a pair of side frames 20 arranged to be separated on the right and left and extended in the up and down direction, an upper frame 11 connecting upper end portions of the pair of side frames 20, and a lower frame 12 connecting lower end portions thereof.

The side frame 20 is formed by pressing a sheet metal, and is formed of an approximate plate body in a substantially D-shape in which a side of the front end is curved and a lower portion of the front end is overhangs in a forward direction.

In the vicinity and the lower portion of the center of the up and down direction of the side frame 20, both ends of a pair of zigzag springs 31 are mounted.

The upper frame 11 is formed of a pipe-shaped body, and is composed of a top frame portion 11a extending in the seat width direction and constituting the top portion of the seat back frame 1, and upper frame side portions 11d formed by extending both ends of the top frame portion 11a downwardly while being curved perpendicularly.

As shown in FIG. 2, to a surface of the front inside of the seat of the upper frame side portions 11d on the right and left, a connection plate 30 is welded and fixed.

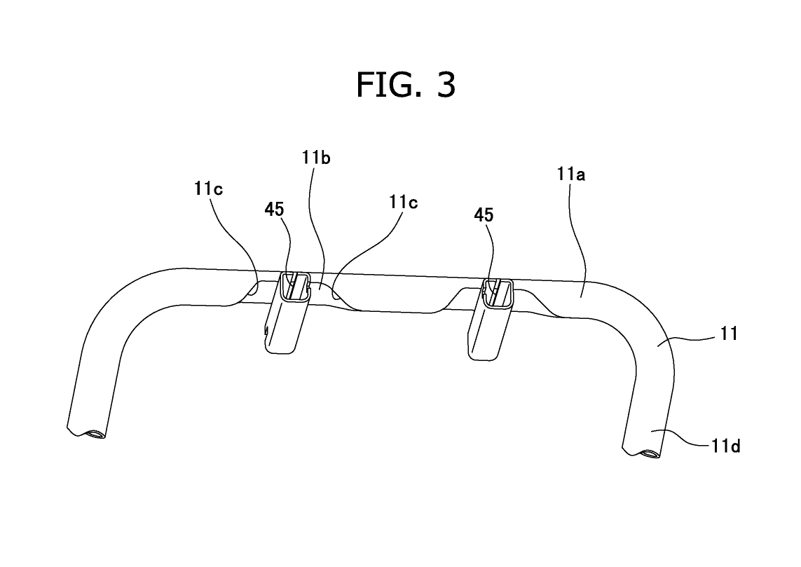

As shown in FIG. 2 and FIG. 3, at two points of the top frame portion 11a of the upper frame 11, recess flat surface portions 11b whose front surface side is formed into a flat surface by crushing are formed. On both sides of the seat width direction of the recess flat surface portion 11b, a pair of recess side surfaces 11c connecting from a surface of the recess flat surface 11b to the front surface consisting of a curved surface of the pipe-shaped portion of the top frame portion 11a are formed, and the recess side surfaces 11c are inclined with respect to the recess flat surface portions 11b.

On the pair of recess flat surface portions 11b, a bracket 40 which supports a support guide 15 supporting the head rest pillar 14 is provided.

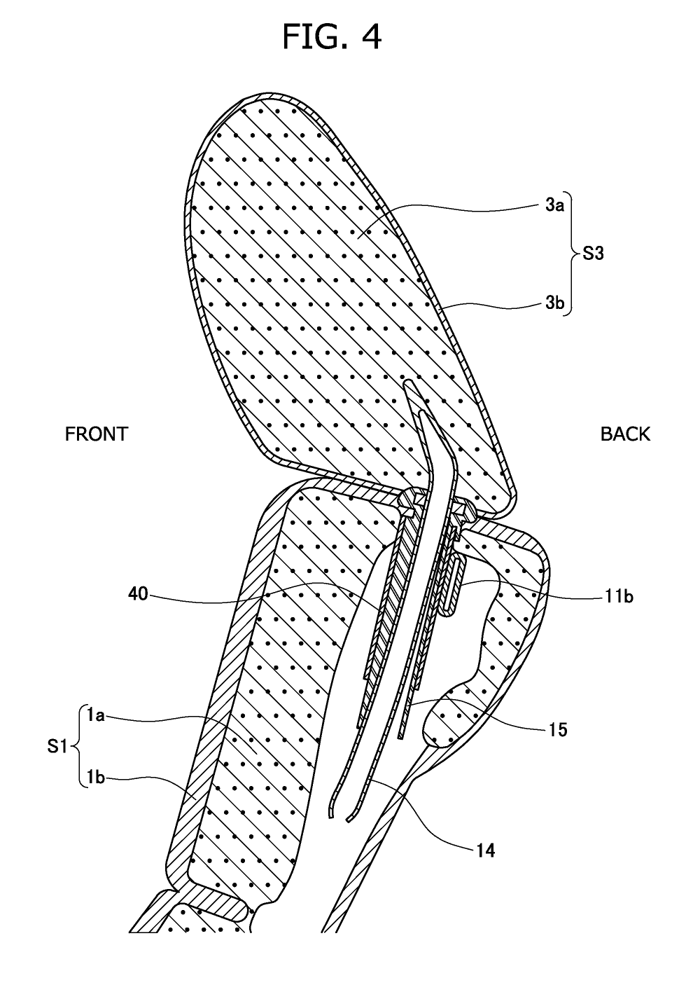

As shown in FIG. 4, the head rest pillar 14 is formed of a pair of metallic rod-shaped bodies, and is curved into a crescent shape to the front of the seat.

The support guide 15 is a member formed by molding a synthetic resin into a cylindrical shape, and includes a cylindrical portion capable of storing the head rest pillar 14 therein, and a head portion which is provided integrally in the upper portion of the cylindrical portion and is exposed to the upper portion than the upper end of the bracket 40 when inserted into the bracket 40.

As shown in FIG. 4, the head rest pillar 14 is inserted into the cylindrical support guide 15 and fixed thereto, and the support guide 15 is inserted into the cylindrical bracket 49 and fitted therein. By installing the support guide 15 and the bracket 40 in this way, the head rest S3 is installed on the seat back S1.

As shown in FIG. 2 and FIG. 3, the bracket 40 is formed of an approximately square tubular shape formed by winding a metal plate into a square tubular shape by way of bending and includes a rear surface 41, and a pair of side surfaces 43 adjacent to the rear surface 41 and perpendicular to the rear surface 41, and a line on which the rear surface 41 intersects with the side surfaces 43 acts as both end portions 42 of the seat width direction of the rear surface 41. In the rear surface 41, a slit 45 extending with the same width from the upper end to the lower end is formed. The rear surface 41 abuts to the recess flat surface portion 11b, and the both end portions 42 are laser-welded to the recess flat surface portion 11b.

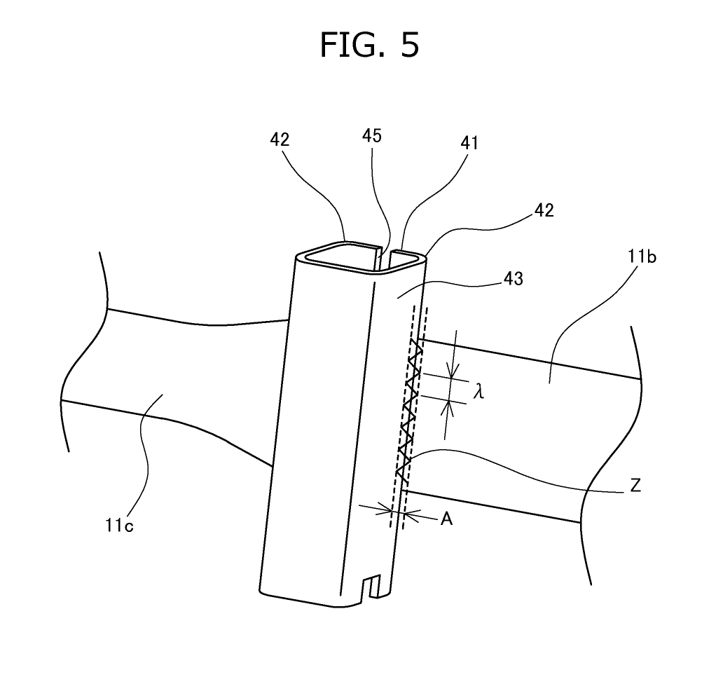

A laser-welding mark 44 extends in the up and down direction of the bracket 40 while drawing a zigzag-shape Z as shown in FIG. 5, at a position where the end portion 42 of the rear surface 41 of the bracket 40 abuts to the recess flat surface portion 11b.

As shown in FIG. 5, the laser-welding mark 44 is provided over the almost entire length from the vicinity of the upper end to the vicinity of the lower end of the recess flat surface portion 11b, but may be formed in at least a portion of the range in the up and down direction where the support guide 15 is provided. For example, the laser-welding mark 44 may be provided only in the vicinity of the center, or may be formed to be divided into the vicinity of the upper end and the vicinity of the lower end. In the present embodiment, as shown in FIG. 4, the support guide 15 is arranged to pass through the entire length from the upper end to the lower end of the bracket 40, but in a case where the support guide 15 is arranged in a portion of the length of the up and down direction of the bracket 40, laser-welding is performed such that the laser-welding mark 44 is formed in at least a portion of the range of the up and down direction of the support guide 15.

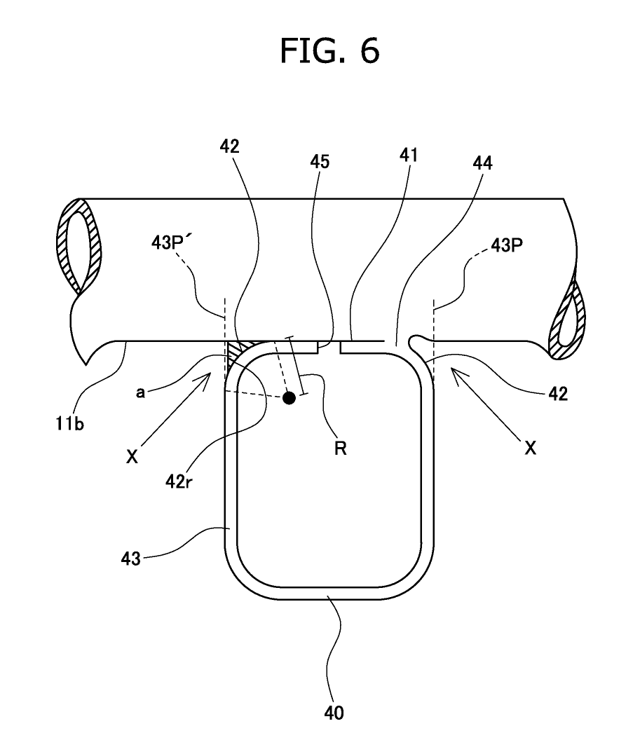

As shown in FIG. 6, the end portion 42 includes an R-shaped portion 42r on the corner. The laser-welding mark 44 is provided in a region “a” surrounded by the R-shaped portion 42r and the recess flat surface portion 11b, on the center side of the seat width direction of the bracket 40 than an extension surface 43P of the side surface 43.

In FIG. 6, the end portion 42 on the right side of the drawing shows a state after laser-welding with the laser-welding mark 44. Moreover, the end portion 42 on the left side of the drawing shows a state before laser-welding.

The zigzag-shape Z has an amplitude A of 0.5-2.0 mm and a wavelength λ of 0.5-2.0 mm, and the amplitude A and the wavelength λ are smaller than a radius curvature R=3.0 mm of the R-shaped portion 42r shown in FIG. 6.

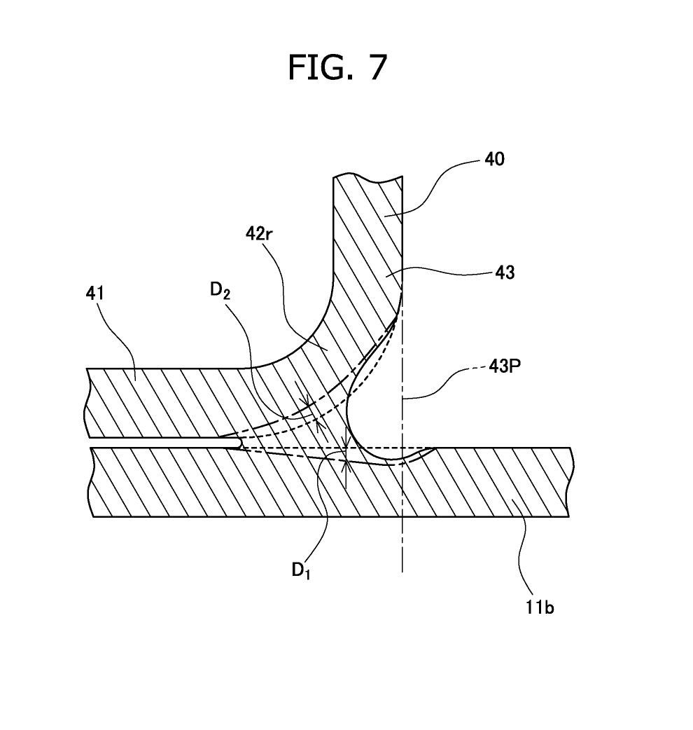

FIG. 7 shows a cross-section of a welded portion of the recess flat surface portion 11b and the bracket 40. As shown in FIG. 7, depths D1 and D2 of a bead molten pool trace due to laser-welding in the recess flat surface portion 11b and the bracket 40 are 5-20% of the thicknesses of the recess flat surface portion 11b and the bracket 40 respectively.

In the present embodiment, since the recess flat surface portion 11b and the bracket 40 are laser-welded, the thermal strain in the welded portion is suppressed. In MIG welding, TIG welding or the like, since the thermal strain is generated in the welded portion, when the bracket 40 and the recess flat surface portion 11b are welded, the bracket 40 may be deformed such that the slit 45 opens to the right and left of the seat width direction and the right and left side surfaces 43 are separated to each other, and shaking may be generated when the bracket 40 and the support guide 15 are fitted. However, in the present embodiment, deformation of the bracket 40 is suppressed, and generation of shaking between the bracket 40 and the support guide 15 is suppressed.

### Welding Method

In the present embodiment, a laser-welding method of joining the recess flat surface portion 11b of the upper frame and the bracket 40 will be described.

In laser-welding of the present embodiment, a publicly known CO2 laser is used, but a publicly known YAG laser may be used. Moreover, heat conduction type laser-welding in which the shape of the bead molten pool is not recessed too much and its width is wider than its depth, is performed.

As shown by an arrow X of FIG. 6, laser is irradiated in an oblique direction to the region “a” surrounded by the recess flat surface portion 11b and the R-shaped portion 42r and in the center side of the seat width direction of the bracket 40 than the extension surface 43P of the side surface 43 to be inclined with an acute angle with respect to the recess flat surface portion 11b and the side surfaces 43.

Laser is irradiated to draw the zigzag-shape Z shown in FIG. 5 by moving a working head and a positioner (both are not shown).

FIG. 6 shows a state after laser-welding the side surface 43 on the right side of the drawing to the recess flat surface portion 11b and shows a state before laser-welding the side surface 43 on the left side of the drawing to the recess flat surface portion 11b.

### Modified Example

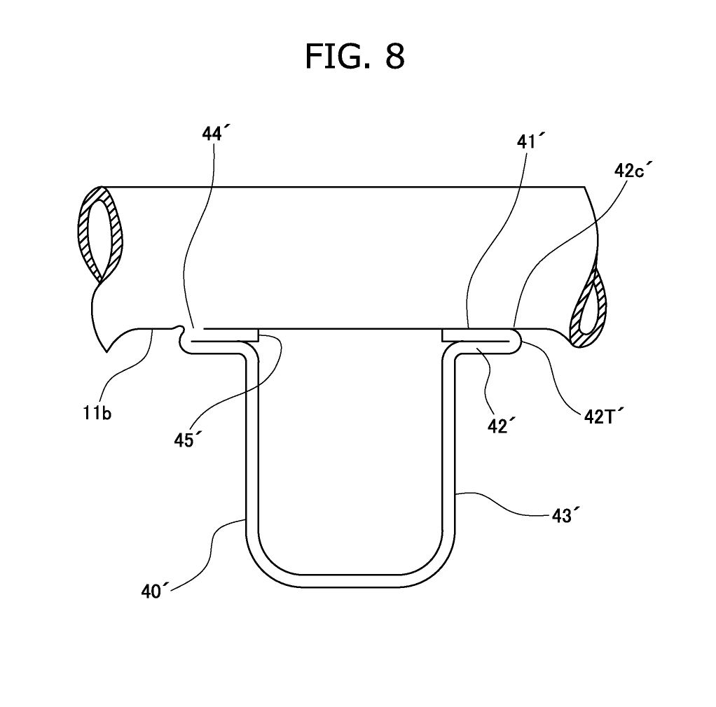

In the present embodiment, the bracket 40 is formed of the shapes shown in FIG. 3, FIG. 5 and FIG. 6, but as shown in FIG. 8, a bracket 40′ formed by forming folded portions 42′ protruding laterally of the seat width direction on the rear ends of a pair of side surfaces 43′ may be used.

The bracket 40′ is formed by winding a metal plate into a square tubular shape by way of bending, the folded portions 42′ in which the metal sheet is folded doubly are formed on both end portions of the metal sheet, and a slit 45′ extending in the up and down direction is formed between the pair of folded portions 42′.

A surface opposite to the side surface 43′ of the folded portion 42′ constitutes a rear surface 41′, and the rear surface 41′ includes the slit 45′ in the center.

In the bracket 40′, a laser-welding mark 44′ extends over a region from a contact surface end portion 42C′ which is an outer end portion of the seat width direction of the abutting surface of the rear surface 41′ and the recess flat surface portion 11b to an outer end portion 42T′ of the seat width direction of the folded portion 42′. The center of the bead fused portion of the laser-welding mark 44′ exists between the contact surface end portion 42C′ and the end portion 42T′.

FIG. 8 shows a state after laser-welding the side surface 43′ on the left side of the drawing to the recess flat surface portion 11b and shows a state before laser-welding the side surface 43′ on the right side of the drawing to the recess flat surface portion 11b.

At laser irradiation, laser is irradiated in such a manner that the center of laser irradiation is aligned between the contact surface end portion 42C′ and the end portion 42T′ and that the end portion 42T′ exists within the irradiated area.

In the example of FIG. 8, molten metal due to laser-welding does not reach a wall surface of the bracket 40′ because laser-welding is performed on an outer surface of the folded portion 42′ not constituting the wall surface of the bracket 40′, and laser-welding does not affect the shape of the wall surface of the bracket 40′ because the welding mark does not reach an inner wall surface of the bracket 40′. As a result, generation of shaking between the bracket 40′ and the support guide 15 is suppressed.

TABLE OF REFERENCE NUMERALS

| D1, D2 | Depth |
|---|---|
| S | Vehicle seat |
| S1 | Seat back |
| S2 | Seating portion |
| S3 | Head rest |
| Z | Zigzag-shape |
| “a” | Region |
| 1 | Seat back frame |
| 1a, 2a | Cushion pad |
| 1b, 2b | Skin material |
| 3a | Pad material |
| 3b | Skin material |
| 11 | Upper frame |
| 11a | Top frame portion |
| 11b | Recess flat surface portion |
| 11c | Recess side surface |
| 11d | Upper frame side portion |
| 12 | Lower frame |
| 14 | Head rest pillar |
| 15 | Support guide |
| 20 | Side frame |
| 30 | Connection plate |
| 31 | Zigzag spring |
| 40, 40′ | Bracket |
| 41, 41′ | Rear surface |
| 42, 42T′ | End portion |
| 42′ | Folded portion |
| 42C′ | Contact surface end portion |
| 42r | R-shaped portion |
| 43, 43′ | Side surface |
| 43P | Extension surface |
| 44, 44′ | Laser-welding mark |
| 45, 45′ | Slit |

1. A seat frame for a vehicle seat, comprising:
a seat back frame with an upper frame; and
a bracket joined to the upper frame and holding a pillar of a headrest;
wherein:
the bracket is fixed to the upper frame by laser-welding.

2. The seat frame for the vehicle seat according to claim 1, wherein:
the bracket supports the pillar of the headrest via a support guide, and
in at least a portion in an up and down direction of the range where the support guide is provided, the bracket is laser-welded to the upper frame in the up and down direction.

3. The seat frame for the vehicle seat according to claim 1, wherein:
the bracket comprises:
a rear surface on the rear of the seat;
a pair of side surfaces provided on side portions of a seat width direction; and
corners between the side surfaces and the rear surface,
on the corners, R-shaped portions connecting the rear surface and the side surfaces by a curve surface are provided,
the upper frame comprises a flat surface portion in which a front surface side of the seat is formed into a flat surface,
a welding mark of laser-welding extending in an up and down direction straddles between the flat surface portion and the R-shaped portion, and
the welding mark comprises a plurality of first welding mark pieces and second welding mark pieces formed along different directions from each other and continuously aligned up and down alternately.

4. The seat frame for the vehicle seat according to claim 3, wherein:
the welding mark comprises a connection portion connecting the R-shaped portion to the flat surface portion to bridge them, and
the connection portion is arranged in a region surrounded by an extension surface of the side surface and the R-shaped portion and the flat surface portion.

5. The seat frame for the vehicle seat according to claim 3, wherein:
a folded portion in which the side surface protrudes outwardly in the width direction is provided on the corner, and
the folded portion and the flat surface are laser-welded.

6. The seat frame for the vehicle seat according to claim 3, wherein:
the upper frame is formed of a pipe-shaped body,
the flat surface portion in which the front surface side of the upper frame is recessed, and a pair of recess side surfaces provided on each side of the seat width direction of the flat surface portion and inclined to connect the flat surface portion and the front surface of the pipe-shaped portion of the upper frame are provided in the central portion of the seat width direction of the upper frame, and
the corner and the flat surface portion are laser-welded at a position facing the recess side surface.

7. The seat frame for the vehicle seat according to claim 5, wherein:
a bead center of the welding mark is located between an outer end portion of the seat width direction of the folded portion and an outer end portion of the seat width direction of a surface contacted by the flat surface portion and the rear surface.

8. The seat frame for the vehicle seat according to claim 5, wherein:
the welding mark reaches the outer end portion of the seat width direction of the folded portion.

9. The seat frame for the vehicle seat according to claim 3, wherein:
the welding mark does not reach a surface on the rear of the upper frame.

10. The seat frame for the vehicle seat according to claim 1, wherein:
the bracket and the upper frame have molten pool traces formed by laser-welding, and the molten pool traces have a depth of 5-20% of the thickness of the bracket and the upper frame respectively.

11. The seat frame for the vehicle seat according to claim 3, wherein:
the first welding mark pieces and the second welding mark pieces are inclined with respect to an insertion direction of the pillar of the head rest into the bracket, and
a distance A of the first welding mark piece and the second welding mark piece in a direction perpendicular to the insertion direction and a sum B of the lengths of the insertion direction of the adjacent pair of the first welding mark piece and the second welding mark piece are smaller than a curvature radius R of the R-shaped portion.

12. A vehicle seat, comprising:
a seat back frame with an upper frame; and
a bracket joined to the upper frame and holding a pillar of a headrest;
wherein:
the bracket is fixed to the upper frame by laser-welding.
